(19) United States
(12) Patent Application Publication
(10) Pub. No.: US 2023/0014051 A1
(43) Pub. Date: Jan. 19, 2023

(54) Shelf-Stable High-Protein Yogurt Products

(71) Applicants: Earl CHRISTIANSEN, Twin Falls, ID (US); Glanbia Nutritionals, Ltd., Kilkenny (IE)

(72) Inventors: Earl Christiansen, Twin Falls, ID (US); Loren S. Ward, Twin Falls, ID (US)

(21) Appl. No.: 17/784,661

(22) PCT Filed: Dec. 11, 2020
(86) PCT No.: PCT/US2020/064691

§ 371 Date: Jun. 12, 2022

Related U.S. Application Data
(60) Provisional application No. 62/946,924, filed on Dec. 11, 2019.
(60) Provisional application No. 63/009,553, filed on Apr. 14, 2020.

(51) Int. Cl. A23C 9/13; A23C 3/03; A23C 9/123; A23L 2/38; A23L 2/66

(52) U.S. Cl. CPC A23C 9/1307; A23C 3/03; A23C 9/123; A23L 2/382; A23L 2/66; A23V 2002/00

(57) ABSTRACT

Disclosed is a method for making shelf-stable yogurt products of viscosities from about 50 centipoise to about 20,000 centipoise, the yogurt products having a total protein content of at least about 12 percent, at least about 75% of the whey protein in the product being undenatured. Also disclosed are products made by the method, such as shelf-stable yogurt drinks comprising at least about 12 percent total protein, wherein at least about 75% of the whey protein is in the undenatured state.

### FIELD OF THE INVENTION

The invention relates to methods for producing high-protein yogurt products that can be stored without refrigeration. More specifically, the invention relates to methods for producing high-protein yogurt products in a range of viscosities, including yogurt beverages, all being shelf-stable.

### BACKGROUND OF THE INVENTION

Yogurt is prepared by fermenting milk with bacterial cultures consisting of a mixture of Streptococcus subsp. thermophilus and Lactobacillus delbrueckisubsp. bulgaricus. There are two major types of yogurt—set and stirred. Set yogurt (which describes fruit-on-the bottom products) is formed in pots, resulting in a continuous gel structure. With stirred yogurt, the gel formed during incubation in large fermentation tanks is disrupted by stirring, and the stirred product can then be pumped through a screen to give the product a smooth, but viscous, texture.

The steps involved in yogurt manufacture generally include standardizing the yogurt milk (e.g., by the addition of milk powder, whey protein powder, etc.), homogenizing the yogurt milk (usually in a two-stage homogenization protocol), pasteurizing the yogurt milk, cooling the milk to a temperature that promotes the growth of the bacterial starter culture (generally about 42° C.), adding the starter culture, and incubating (i.e., “culturing”) the yogurt milk with starter culture. When describing the steps of yogurt processing, however, the pasteurization step is often listed as “heat-treating,” rather than pasteurization—because in the industry, the pasteurization step actually serves multiple purposes. First, heat-treatment can be used to kill pathogenic bacteria—and bacteria that might compete with the bacteria in the starter culture. But, heat-treatment also provides a means by which the proteins can be denatured, particularly the whey proteins that, if denatured, crosslink with casein proteins to form the yogurt gel. Since this denaturation takes place at temperatures that are higher than those that are minimally-required to kill bacteria, the industry standard has been to use higher temperatures and temperature/time combinations that are targeted to denature the protein. Temperature/time combinations for the pasteurization step commonly used in the yogurt industry include 85° C. for 30 minutes, or 90-95° C. for 5 minutes. Sometimes, very high temperature short time (100° C. to 130° C. for 4 to 16 seconds) or ultra-heat temperature (UHT) (140° C. for 4 to 16 seconds) are used.

Fermentation of the yogurt milk by the bacterial culture converts lactose into lactic acid, reducing the pH of the milk. This fermentation produces the characteristic yogurt taste. During the acidification, the pH decreases from 6.7 to less than or about pH 4.6, creating a viscoelastic gel. Increased yogurt viscosity is also observed when the total solids content of milk is increased.

The heating step (pasteurization) is important for food safety, but it is also considered to be critical for the formation of the viscoelastic gel, creating a yogurt product from yogurt milk. According to Lee and Lucey (Formation and Physical Properties of Yogurt, Asian-Aust. J. Anim. Sci. (2010) 23(9):1127-1136) native whey proteins from unheated milk are “inert fillers” in yogurt. It takes the heating step to make the proteins useful for the formation of the yogurt gel. When milk is heated at greater than 70° C., the major whey proteins, such as ß-lactoglobulin, are denatured, the 3-lactoglobulin interacts with K-casein by disulfide bridging, resulting in increased gel firmness and viscosity of yogurt. They disclose that denatured whey proteins attaching to the surface of casein micelles are critical to the increased stiffness of yogurt gels made from heated milk.

“Whey protein” is a general term describing the proteins found in the aqueous fraction of milk that is removed during cheese making. Proteins, peptides and enzymes found in whey include ß-lactoglobulin, a-lactalbumin, glycomacropeptide (GMP), bovine serum albumin (BSA), immunoglobulins, lactoferrin and lactoperoxidase. Denaturation of whey proteins is also considered to be important for increasing stiffness, firmness, viscosity and water holding capacity of yogurt gels (Pakseresht, S., et al. Optimization of low-fat set-type yoghurt: effect of altered whey protein to casein ratio, fat content and microbial transglutaminase on rheological and sensorial properties, J Food Sci Technol. (2017) 54(8): 2351-2360). Native (undenatured) whey proteins, however, provide some nutritional benefits that are better than those of denatured whey proteins. For example, 20 g of native whey induced a significantly faster increase and higher peak values in blood leucine concentrations than 20 g of MWP, WPH, WPC-80 and milk after a bout of strength training (Hamarsland, H., Native whey induces higher and faster leucinemia than other whey protein supplements and milk: a randomized controlled trial, BMC Nutrition (2017) 3:10). Based on studies in mice, native whey has also been proposed to promote an improved immune response and higher glutathione levels than does denatured whey (Bounous, G. et al. The Biological Activity of Undenatured Dietary Whey Proteins: Role of Glutathione, Clin. Invest. Med. (1991) 14: 296-309.

Yogurt is a staple food in many countries. It is a source of protein, calcium, phosphorus, B vitamins (Riboflavin and B12), tryptophan, vitamin C, folate, and zinc. However, yogurt is a perishable product, which can limit its distribution and its appeal to a broad customer base. Yogurt is generally shipped and stored under refrigeration. Shelf-stable yogurt products (not high-protein) are commercially available, however, and are generally packaged for long-term storage using one of two processing methods—aseptic processing or retort processing. Retort processing is generally associated with metal cans, and therefore may impart a metallic taste to the product. Retort processing also involves prolonged processing time, with an application of heat (about 250-300° F.) for a period of about 30-45 minutes, while the processing time for aseptic processing is generally only about 4-5 minutes at 300° F. The milder processing conditions used in aseptic processing decrease the level of denaturation of the proteins in the product—about 85+ percent of protein in products processed using retort processing is denatured, while less than 15 percent of the protein in a product packaged using aseptic processing is denatured. Aseptic processing conditions can also decrease vitamin loss in a product by at least 50 percent as compared to retort processing.

Shelf-stable high-protein yogurt products could be desirable for use by athletes (who could simply drop a container into a gym bag or backpack and not worry about having to refrigerate the product), organizations such as schools that feed large numbers of people and have limited refrigeration space, and others. Shelf-stable high-protein yogurt products could also be highly useful in situations, such as following natural disasters, when electricity is not available to power refrigeration units. What are needed are ways to produce shelf-stable high-protein yogurt products, and methods for providing shelf-stable high-protein yogurt products in a variety of forms—from custards and dips, to high-protein drinkable yogurts.

### SUMMARY OF THE INVENTION

The invention relates to a method for producing at least one shelf-stable yogurt product having a total protein content of at least about 12 percent, the method comprising the steps of (a) preparing a fermentable yogurt milk by adding to milk at least one casein-containing component and/or at least one whey protein-containing component to give a whey:casein ratio of from about 20:80 to about 90:10 in the fermentable yogurt milk; (b) culturing the fermentable yogurt milk with at least one bacterial culture to produce at least one yogurt product; and (c) aseptically packaging the yogurt product to provide a shelf-stable yogurt product, wherein at least one heat treatment is performed after step (a) and/or step (b) under pasteurization conditions that maintain at least about 75 percent of the whey protein in its undenatured state. In various aspects, the casein-containing component is selected from the group consisting of milk, cream, skim milk, MPC, MPI, non-fat dry milk (NFDM), UF milk, and combinations thereof. In various aspects, the whey protein-containing component is selected from the group consisting of milk, cream, skim milk, MPC, MPI, non-fat dry milk (NFDM), UF milk, WPC, WPI, and combinations thereof. In various aspects of the invention, the milk is liquid milk and/or milk powder admixed with water.

In various embodiments of the method, the viscosity of the shelf-stable yogurt product can range from about 50 cP to about 20,000 cP. In various aspects of the invention, the total protein content in the shelf-stable yogurt product is from about 12 to about 25 percent. In various aspects, the aseptically-packaged yogurt product comprises at least about 75 percent of the protein in its native form.

### BRIEF DESCRIPTION OF THE DRAWINGS

FIG. 1 is a photo of a thin (e.g., drinkable) yogurt product made by adjusting the protein ratio to give a viscosity of 1150 cP, using 80% whole milk and 20% wpi (20% protein), heat-treated (pasteurized) at 166° F. for 15 seconds, and homogenized at 2500 psi. Products such as this drinkable yogurt can readily be packaged using aseptic fill techniques to provide shelf-stable drinkable yogurts.

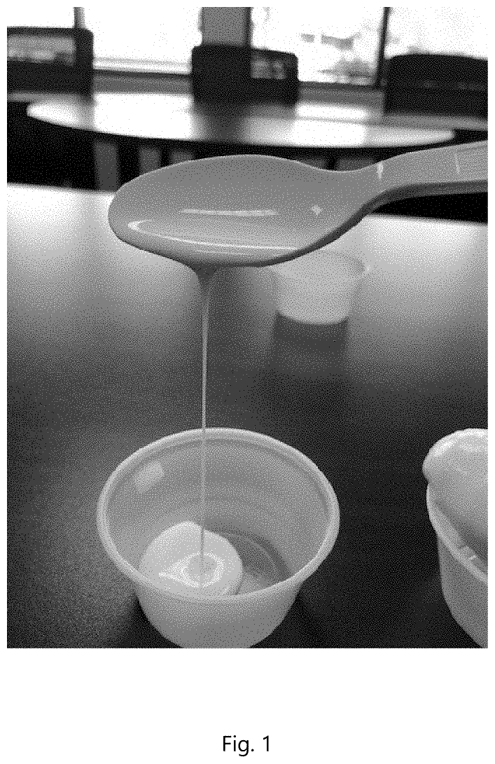

FIG. 2 is a photo of a thick (full-bodied) yogurt product made by adjusting the protein ratio to give a viscosity of 30,000 cP, using 80% whole milk, 10% MPI, and 10% WPI (20% protein), heat-treated at 166° F. for 15 seconds, and homogenized at 2500 psi.

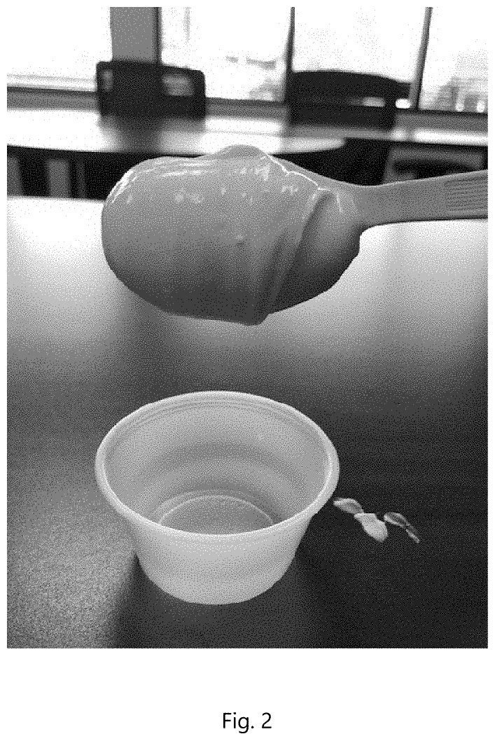

### DETAILED DESCRIPTION

Disclosed is a method for manufacturing shelf-stable yogurt products, wherein mild pasteurization conditions are combined with casein-to-whey ratio adjustment to produce yogurt products having viscosity that can be targeted within a range of from about 50 cP to about 20,000 cP. Lower-viscosity products can comprise drinkable yogurt products, yogurt syrups, and other flowable products, which can be packaged using aseptic packaging techniques to provide shelf-stable drinkable yogurts, syrups, etc. Higher-viscosity products such as shelf-stable yogurt dips, for example, can also be made by the method of the invention, for shipment, storage, and used without refrigeration. In the range of whey-to-casein ratios of from about 20:80 to about 90:10, higher casein-to-whey ratios shift the viscosity toward thicker products and higher whey-to-casein ratios shift the viscosity toward that of thinner, more flowable products. Examples of the effect of the casein/whey ratio on yogurt product viscosity are shown below in Table 1.

TABLE 1
Effect of Casein/Whey Ratio on Yogurt Product Viscosity

| | | Approximate |
|---|---|---|
| Product Viscosity | % Casein vs. Whey | Casein/Whey Ratio |
| Thin (e.g., Drinkable) | 19%/81% | 1:4 |
| Spoonable | 32%/68% | 1:2 |
| Thick | 52%/48% | 1:1 |

A yogurt product produced by the method will have at least about 75 percent of the whey protein in its undenatured (i.e., native) state.

Unless stated otherwise, amounts (particularly those of whey and casein) are given on an as-is basis (e.g., as grams per 100 g finished product). The term “shelf-stable high-protein yogurt product,” as used herein, is a fermented milk product made by the method of the invention. Yogurt products made according to the inventor's method can have viscosities ranging from about 50 cP to about 200,000 cP, although for the purpose of producing those as shelf-stable products packaged using aseptic fill technologies it is preferable to target a range of from about 50 cP to about 20,000 cP. “Yogurt” is defined by the United States Food and Drug Administration, for example, as a product that is produced by culturing dairy ingredients using lactic acid-producing bacteria. It will be understood by those of skill in the art, given the disclosure herein, that the method can also be applied to the manufacture of other cultured dairy products such as, for example, kefir, labneh, ymer, and buttermilk. Therefore, the terms “yogurt product” and “drinkable yogurt” can be interpreted more broadly to include similar types of cultured dairy products such as those listed above. Dairy ingredients for yogurt production comprise cream, milk, partially skimmed milk, skim milk, and combinations thereof. Other optional ingredients include, for example, concentrated skim milk, nonfat dry milk, buttermilk, whey, lactose, lactalbumins, and lactoglobulins. Products made by the method of the invention meet this definition, while providing a range of products—from drinkable beverages to spreadable, thick products—that provide excellent options for consumers. “Native protein(s)” and “undenatured protein(s)” may be used interchangeably herein, both referring to proteins that are functional, being generally unaltered by denaturation due to the heat used in pasteurization/heat treatment. The term “shelf-stable,” as it is applied to yogurt products, means that the products are stable (i.e., they maintain their consistency and their quality, do not spoil, etc.) under ambient storage conditions (e.g., without refrigeration or freezing) for a period of from about 6 to about 12 months. “High protein,” in the context of the present invention, means protein levels of at least about 12%. “High protein” yogurt is, in the industry, generally a yogurt product having a protein content of at least about 8%. The present invention makes it possible to significantly exceed those levels with protein that has substantially all been added before the yogurt is fermented (i.e., not added after fermentation simply to increase the protein in the packaged product, which could adversely affect the taste of the product).

There has long been a need for shelf-stable yogurt products, given the nutritional benefits provided by yogurt, as well as the broad consumer acceptance of yogurt products. However, it has been difficult enough to produce shelf-stable yogurt products having the desirable taste and consistency of yogurt, and to produce high-protein yogurts which have the desirable taste and consistency of yogurt, without combining the challenges presented by both. But, the inventor has developed a way to produce high-protein yogurts that are also shelf-stable. Furthermore, the method developed by the inventor can be used, in its different aspects, to make a variety of yogurt products of different viscosities—ranging from thick pudding-type yogurt products, dips, and high-protein Greek-type yogurts, to yogurt syrups and yogurt drinks.

In the method used to produce shelf-stable high-protein yogurt products, yogurt milk is prepared by adding to the milk at least one protein-containing component selected from the group consisting of at least one casein-containing component, at least one whey protein-containing component, and combinations thereof, to give a whey/casein ratio of from about 20:80 to about 90:10 in the yogurt milk. The yogurt milk can then be heat-treated at a pasteurization temperature that retains at least about 75 percent of the whey protein in its undenatured state. Generally, this can be accomplished, for example, by using pasteurization temperatures that meet the requirements of the United States Food and Drug Administration's Pasteurized Milk Ordinance, choosing temperatures that are on the low end of the range of temperatures that meet those requirements or higher temperatures with shorter pasteurization times, the combination of which accomplishes the goal of pasteurizing the milk while maintaining at least about 75 of the whey protein in its undenatured state. Although it is common in the industry to denature the whey protein during pasteurization in order to produce the yogurt gel, the inventor has found that denaturation is not necessary. The yogurt milk is inoculated with at least one bacterial culture to produce a cultured yogurt product. The addition of the at least one protein-containing component results in a total protein content in this cultured yogurt product of at least about 12 percent (e.g., from about 12 percent to about 25 percent). Adjustment of the amount and ratio of the protein-containing component that is added to the yogurt milk results in a corresponding viscosity of the yogurt product from about 50 cP to about 200,000 cP. For the purpose of producing shelf-stable products which are packaged using aseptic fill techniques, the target viscosity would generally be in the range from about 50 cP to about 20,000 cP.

By way of illustration, a syrup such as corn syrup typically has a viscosity of 50-100 cP, and peanut butter typically has a viscosity in the range of from about 150,000 cP to about 200,000 cP. The viscosity of commercial Greek yogurt is generally about 21,000 cP (centipoise, also abbreviated herein as cps). Therefore, the method provides a manufacturer with the option of producing drinkable yogurt products, yogurt products having a standard viscosity, yogurt products with a viscosity similar to that of Greek yogurt, and yogurt products having a viscosity similar to that of thick peanut butter, for example.

Standard methods for producing yogurt are known to those of skill in the art, and these methods can be used to make products according to the method of the invention, utilizing pasteurization temperatures that are mild enough to generally maintain whey protein in its native state and ingredients that provide a higher casein-to-whey ratio for more viscous yogurt products (e.g., spreadable yogurt product) or a higher whey-to-casein ratio for drinkable yogurt products, for example. In the present method, heat treatment can be performed at one, or both, of two points during the process of making and packaging the shelf-stable yogurt. Heat treatment, preferably as pasteurization, can be beneficial prior to the addition of the bacterial yogurt cultures. Heat treatment (pasteurization) to make sure that there are no bacteria in the packaged product which could cause spoilage over the storage period is important for product safety. What is important to the method of the invention is that if either of these heat treatments is done for the purpose of pasteurizing the ingredients or the product thereof, the pasteurization conditions should be selected so that at least about 75 percent of the whey protein in the shelf-stable yogurt product remains in its native state. That is, pasteurization conditions should be selected so that no more than about 25 percent of the whey protein in the shelf-stable yogurt product is denatured by the pasteurization process. These pasteurization conditions can generally be met by what are known in the industry as “minimum pasteurization conditions.”

Materials for yogurt production can be selected from raw or pasteurized milk, separated raw or pasteurized cream, raw or pasteurized skim milk, nonfat dry milk (NFDM), whey protein concentrate (WPC), whey protein isolate (WPI), milk protein concentrate (MPC), liquid UF milk retentate (“UF milk,” milk filtered to produce a lower lactose, higher protein product than standard milk), and milk protein isolate (MPI), for example. In various aspects, the protein-containing component is selected from the group consisting of milk, cream, skim milk, WPC, WPI, MPC, MPI, non-fat dry milk (NFDM), and combinations thereof. Various combinations of these ingredients are used to produce products having viscosities within the range of from about 50 centipoise (cP) to about 20,000 centipoise (cP). For example, as shown below in Table 2, varying the amounts of WPI and MPC added to the yogurt milk can produce products having different levels of protein, as well as different viscosities, while the yogurt products maintain high levels of undenatured whey protein in the whey protein fraction of the products.

TABLE 2
Protein Sources and Amounts - Yogurt Products

| | | Drinkable | Medium Body | Heavy Body |
|---|---|---|---|---|
| 11% Protein | Milk | 90% | 90% | 90% |
| | WPI | 8.25% | 5% | 3.75% |
| | MPC | 1.75% | 5% | 6.25% |
| 17% Protein | Milk | 83% | 83% | 83% |
| | WPI | 14.5% | 8.5% | 6.75% |
| | MPC | 1.5% | 8.5% | 10.25% |
| 25% Protein | Milk | 74% | 73.3% | 73% |
| | WPI | 25% | 13.25% | 10.75% |
| | MPC | 1% | 13.25% | 16.25% |

To make yogurt products according to the invention, pasteurization conditions can include minimum pasteurization temperatures for appropriate holding times, flash pasteurization (high temperature, short time, 166° F. for 15 seconds), batch pasteurization (150° F. for 30 minutes), or higher heat shorter time (HHST, 194° F. for 0.5 seconds), for example. Yogurt milk and added ingredients are homogenized and cooled to fermentation temperatures of 95-112° F. (about 42° C.). Bacterial starter culture is added, and the mixture is fermented to a final pH of 4.3 to 4.75, then stirred, sheared and cooled to 35-50° F. Bacterial cultures for yogurt generally include Streptococcus subsp. thermophllus and Lactobacillus delbrueckii subsp. bulgaricus, but a variety of lactic acid-producing and/or probiotic bacteria can also be used in the production of yogurt products according to the method of the invention. These bacteria include, for example, Lactobacillus acidophilus, L. fermentum, L. paracasei, L. brevis, L. gasseri, L. plantarum, L. bulgaricus, L. helveticus, L. reuten, L. casei, L. jensenk L. rhamnosus, L. crispatus, L. johnsonk L. salivarius, Bifidobacterium adolescentis, B. breve, B. longum, B. animalis, B. infantis, B. thermophilum, B. bifidum, and B. lactis. At this point, flavor can be added, the yogurt can be mixed with fruit, etc., and it can be dispensed into appropriate containers for storage, shipping, and sale.

Whey protein is commonly provided as whey protein isolate (WPI) or whey protein concentrate (WPC). Milk protein isolate (MPI) contains whey protein, but the whey protein composition is only a fraction of the total protein content—the primary protein component in milk being casein. Whey protein concentrates and isolates can be produced by various means, which generally involve separation technologies such as, for example, filtration methods. Preferred whey protein compositions comprise whey protein isolates that provide the major whey proteins comprising beta-lactoglobulin, alpha-lactalbumin, glycomacropeptide (GMP), immunoglobulins, bovine serum albumin (BSA), and lactoferrin. Maintaining the whey proteins in the native (undenatured) state provides protein functionality in the resulting yogurt product that enhances its nutritional value. Beta-lactoglobulin, for example, is rich in cysteine, an important amino acid in the synthesis of glutathione. Alpha-lactalbumin is an important source of bioactive peptides and essential amino acids, including tryptophan, lysine, branched-chain amino acids, and sulfur-containing amino acids. Glycomacropeptide (GMP) is a C-terminal part (106-169) of kappa-casein that is released into whey during cheese making. Glycomacropeptide may help control and inhibit the formation of dental plaque and dental caries, promotes satiety, and has been reported to have antimicrobial, anticariogenic, gastric acid inhibitory, cholecystokinin-releasing, prebiotic, and immune modulatory benefits. Bovine serum albumin has fatty-acid binding, antimutagenic, and cancer prevention effects. Lactoferrin can be beneficial for treatment of stomach and intestinal ulcers, diarrhea, and hepatitis C infection. It has antioxidant activity and protects against bacterial and viral infections. It is an immune modulator, prevents tissue damage related to aging, promotes healthy intestinal bacteria, may prevent some forms of cancer, and regulates the way the body processes iron. Table 3 lists the major protein fractions, and their relative percentages, in a commercially-available whey protein isolate used by the inventor in the method of the invention.

TABLE 3
Protein Composition of a Commercially-Available
Whey Protein Isolate*

| | |
|---|---|
| Beta-Lactoglobulin | 52.9% |
| Alpha-Lactalbumin | 22.4% |
| Glycomacropeptide | 21.0% |
| Immunoglobulins | 1.8% |
| Bovine Serum Albumin | 1.4% |
| Lactoferrin | 0.5% |

*Provon ®, Glanbia Nutritionals, Inc., Monroe, Wisconsin

Minimum pasteurization conditions are known to those of skill in the art of dairy food production. These conditions are generally the minimum processing conditions needed to kill Coxiella burnetii, the organism that causes Q fever in humans. C. burnetii is the most heat-resistant pathogen currently recognized in milk. In the United States, for example, the Pasteurized Milk Ordinance (PMO) mandates the conditions which must be met in order to achieve minimum pasteurization conditions. Interestingly, however, pasteurization can be achieved with minimal levels of denaturation of the important proteins that can be found in milk-5 percent or less of the whey protein, for example—although because of the general consensus that denaturation of whey protein (especially beta-lactoglobulin) is necessary for yogurt processing and the formation of yogurt gels, it has been customary in the industry to use pasteurization conditions that are designed to result in protein denaturation, although they are not required by the PMO. The inventor has discovered that yogurt products of desirable gel strength and viscosity can be produced without denaturing the whey protein, and in fact, that by utilizing pasteurization conditions that maintain the undenatured state of the proteins, it is possible to produce products of varying viscosities that can be targeted specifically by a dairy processor by adjusting the amounts of proteins that can be added to the yogurt milk, and even more importantly, by adjusting the ratio of the casein proteins to the whey proteins. Table 4 lists temperature and time combinations that are considered sufficient to destroy C. burneti and meet the legal standard for pasteurization. These temperature/time combinations can be used in the method of the invention to achieve pasteurization while maintaining at least about 75 percent of the whey protein in its undenatured state. Generally, these combinations can produce the desired pasteurization effect while producing minimal denaturation (e.g., less than 10% denaturation of the whey proteins).

TABLE 4
Temperature and Time Combinations for Milk Product Pasteurization

| Temperature | Time | Pasteurization Type |
|---|---|---|
| 63° C. (145° F.) | 30 minutes | Vat Pasteurization |
| 72° C. (161° F.) | 15 seconds | High temperature short time |
| | | Pasteurization (HTST) |
| 89° C. (191° F.) | 1.0 second | Higher-Heat Shorter Time (HHST) |
| 90° C. (194° F.) | 0.5 seconds | Higher-Heat Shorter Time (HHST) |
| 94° C. (201° F.) | 0.1 seconds | Higher-Heat Shorter Time (HHST) |
| 96° C. (204° F.) | 0.05 seconds | Higher-Heat Shorter Time (HHST) |
| 100° C. (212° F.) | 0.01 seconds | Higher-Heat Shorter Time (HHST) |
| 138° C. (280° F.) | 2.0 seconds | Ultra-Pasteurization (UP) |

If the milk product is concentrated (condensed), the temperature is increased by 3° C. (5° F.). Source: International Dairy Foods Association (IDFA), https://www.idfa.org/news-views/media-kits/milk/pasteurization.

Others have previously described yogurt products having a percentage of undenatured whey protein (EP3042565A1, Jorgensen et al.) However, Jorgensen et al. use separation technology to isolate the components of the yogurt milk and then remix them. More importantly, they teach heating the mixture of casein and native whey protein at a temperature and for a time period sufficient to obtain denaturation of 30 to 70 percent of the native whey protein of the mixture. The present invention does not require such separation of the components of the yogurt milk, and the inventor has discovered that yogurt products of desirable viscosity can readily be made without denaturing such a significant amount of the whey protein. In fact, the inventor has made several products—from drinkable yogurts to spreadable yogurts—that have no detectable denatured protein in them.

Pasteurization conditions for specific products made using the method of the invention can be readily determined by those of skill in the art, given the information provided herein. Minimum legal requirements are well-known, and the kinetics of denaturation of beta-lactoglobulin has been previously reported (Sava, N. et al. The Kinetics of Heat-Induced Structural Changes of ß-Lactoglobulin, J. Dairy Sci. (2005) 88:1646-1653).

The invention provides, in various aspects, shelf-stable drinkable yogurt products that are actually fermented liquid yogurts. Generally, yogurt drinks are produced by using standard yogurt or Greek yogurt as an ingredient that is added into liquid to give a beverage with a yogurt flavor. Yogurts produced by conventional methods are used, so the proteins in the resulting yogurt drink are in their denatured state. The present method provides liquid yogurts that can be formulated as 100% yogurt (with added protein to provide a high-protein yogurt), and those beverages can comprise greater than 75% undenatured whey protein. Preferably, about 90% of the whey proteins are undenatured. Drinkable yogurts made by the method of the invention therefore can provide the benefits discussed above that are provided by the undenatured whey proteins incorporated into them. Drinkable yogurts made by the method of the invention can be aseptically packaged to produce shelf-stable products that can be shipped and stored without requiring refrigeration. Methods for aseptically packaging yogurt products are known to those of skill in the art, and machines are available for aseptically filling yogurt cups, pouches, bottles, etc. Aseptic techniques known to those of skill in the art include H202-steam, pulsed-light, UVC radiation, injection of hydrogen peroxide vapor into the preform of a PET bottle right before the preform heating stage, etc. Aseptic fill methods can include, for example, either cold or warm sterile fill technologies. Aseptic packaging suitable for yogurt and yogurt drinks can include pouches, bag-in-box packaging, plastic bottles, etc. Suitable methods and packaging products can readily be selected by those of skill in the art. Aseptic filling equipment can be obtained commercially from companies such as Syntegon Technology GmbH, for example.

Yogurt products made by the method of the invention may also contain colorings, flavorings, and other ingredients as desired by the manufacturer of the yogurt product. However, they can also be as “clean label” as having milk, whey protein, and casein as ingredients—all-natural ingredients.

Yogurt products of the invention can include liquid yogurts, yogurt syrups, standard yogurts, Greek yogurts, yogurt pastes, spreadable yogurt products, yogurt in a sleeve or tube that can be eaten by squeezing the tube or by means of a packaging similar to that of an ice cream treat such as what is known as push-pop (sold under brand names such as PushUp®, PopUp®, and)Push-Em®.

One additional advantage provided by the invention that should be pointed out is that the method allows for the production of high-protein yogurt products having protein levels higher than that of conventional commercially-available yogurt products. Table 5 lists the protein content of a variety of commercially-available yogurt products. It is not surprising that the higher protein content products are the Greek yogurts, so the list below includes only Greek yogurt products. Current commercially-available products must also be stored under refrigeration, which increases the overall cost and can be less convenient than a shelf-stable product.

TABLE 5
Protein Content - Commercially-Available Greek Yogurt

| | | AMOUNT OF | |
|---|---|---|---|
| | SERVING | PROTEIN | % |
| BRAND NAME | SIZE (GMS) | (GMS) | PROTEIN |
| Chobani | 170 | 16 | 9.4% |
| Yoplait | 170 | 16 | 9.4% |
| Fage | 170 | 17 | 10.0% |
| Activia | 170 | 16 | 9.4% |
| Stonyfield | 227 | 21 | 9.3% |
| Oikos | 170 | 13 | 7.6% |
| Two Good | 170 | 14 | 8.2% |
| Nounos | 150 | 15 | 10.0% |
| Great Value | 170 | 17 | 10.0% |
| Member's Mark | 170 | 18 | 10.6% |
| Kroger | 150 | 15 | 10.0% |
| Simple Truth | 170 | 15 | 8.8% |
| Odyssey | 150 | 13 | 8.7% |
| Kirkland | 170 | 16 | 9.4% |
| Trader Joe's | 227 | 22 | 9.7% |
| Friendly Farms | 170 | 16 | 9.4% |

As shown above, even in the higher-protein Greek yogurts protein levels are generally no more than 11%. The method of the invention provides yogurt products of viscosities that can be varied as desired, while also providing yogurt products having total protein content (i.e., including both the casein and whey protein fractions) that can be at least about 12 percent. In various embodiments, total protein content can comprise from about 12 to about 25 percent, for example.

Where the term “comprising” is used herein, it should be understood that the terms “consisting of” and “consisting essentially of” can also be used to describe the invention and its steps in instances where a narrower interpretation of the claims may be intended.

The invention will now be described by means of the following non-limiting examples.

### EXAMPLES

### Production of Shelf-stable Ambient Storage Yogurt

Whole milk, whey protein isolate (WPI), and milk protein isolate (MPI) were mixed (88% whole milk, 11% WPI,1% MPI) to give a yogurt milk composition comprising 15% protein. Protein was hydrated for 20 minutes at 90 degrees Fahrenheit for 30 minutes, then pasteurization was performed at 167° F. for 20 seconds. The pasteurized product was homogenized at 2500 psi, cooled to 108° F. (about 42° C.), and inoculated with commercial yogurt culture. The inoculated mixture was incubated (cultured) at 108° F. until the pH reached 4.65 (5 hours), and the set yogurt was broken with agitation. The yogurt product was pasteurized at 166° F. for 6 seconds, aseptically mixed with flavor, and filled into aseptic containers.

### Comparison of Shelf-Stable Yogurt Formulas

Four formulas, as shown in Table 6, were used to prepare four batches of yogurt drinks. (Ingredients in Table 6 are expressed as a percentage, by weight.) First, all ingredients were combined and held at 90 degrees Fahrenheit for 30 minutes. Pasteurization was then performed at 167° F. for 20 seconds. The pasteurized mixture was homogenized at 2500 psi, then cooled to 110° F. The cooled mixture was inoculated with yogurt culture, and when the cultured product reached a pH of 4.65, it was agitated, then heat-treated again, at 166° F. for 6 seconds. The resulting yogurt product was cooled to 70° F. and aseptically filled into sterile containers.

TABLE 6
Shelf-Stable Yogurt Beverage Formulas

| Ingredient | Formula 1 | Formula 2 | Formula 3 | Formula 4 |
|---|---|---|---|---|
| Whole Milk | 88 | 88 | 82 | 81 |
| WPI | 12 | 11 | 16 | 16 |
| MPI | | 1 | 2 | 2 |
| Pectin | | | | 1 |
| (Grindsted | | | | |
| AMD) | | | | |

Containers of product representing each of the four formulas were opened over the course of a period of from 0 to 120 days, with all products tested passing microbial safety testing at all stages of that shelf-life. Products were assessed by determining pH, and observing the color, taste, degree of separation, amount of sludge present in the product, and the products' viscosity. Results are shown in Tables 7-10.

TABLE 7
Formula 1 - Evaluation Over 120-Day Storage

| | Time | 14 | | 30 | | 45 | | 60 | | 90 | | 120 | |
|---|---|---|---|---|---|---|---|---|---|---|---|---|---|
| | 0 | Days | | Days | | Days | | Days | | Days | | Days | |
| pH | 4.65 | 4.6 | | 4.55 | | 4.55 | | 4.55 | | 4.5 | | 4.5 | |
| Color | White | Off- | | Off- | | Off- | | Off- | | Off- | | Off- | |
| | | white | | white | | white | | white | | white | | white | |
| Taste | Good | Good | | Good | | Good | | Good | | Good | | Good | |
| Separation | None | 2 | mm | 20 | mm | 30 | mm | 40 | mm | 40 | mm | 40 | mm |
| Sludge | None | 5 | mm | 10 | mm | 10 | mm | 10 | mm | 12 | mm | 12 | mm |
| Viscosity | 1500 cps | 1800 | cps | 1900 | cps | 1850 | cps | 1700 | cps | 1400 | cps | 1400 | cps |

TABLE 8
Formula 2 -Evaluation Over 120-Day Storage

| | Time | 14 | | 30 | | 45 | | 60 | | 90 | | 120 | |
|---|---|---|---|---|---|---|---|---|---|---|---|---|---|
| | 0 | Days | | Days | | Days | | Days | | Days | | Days | |
| pH | 4.7 | 4.6 | | 4.55 | | 4.55 | | 4.5 | | 4.4 | | 4.4 | |
| Color | White | Off- | | Off- | | Off- | | Off- | | Off- | | Off- | |
| | | white | | white | | white | | white | | white | | white | |
| Taste | Good | Good | | Good | | Good | | Good | | Good | | Good | |
| Separation | None | None | | 2 | mm | 5 | mm | 10 | mm | 20 | mm | 20 | mm |
| Sludge | None | 2 | mm | 3 | mm | 5 | mm | 10 | mm | 10 | mm | 12 | mm |
| Viscosity | 1800 cps | 1900 | cps | 2000 | cps | 2000 | cps | 2000 | cps | 1900 | cps | 1900 | cps |

TABLE 9
Formula 3 - Evaluation Over 90-Day Storage

| | Time | 14 | 30 | | 45 | | 60 | | 90 | |
|---|---|---|---|---|---|---|---|---|---|---|
| | 0 | Days | Days | | Days | | Days | | Days | |
| pH | 4.6 | 4.6 | 4.55 | | 4.55 | | 4.5 | | 4.4 | |
| Color | White | Off-white | Off-white | | Off-white | | Off-white | | Off-white | |
| Taste | Good | Good | Good | | Good | | Good | | Good | |
| Separation | None | None | 2 | mm | 5 | mm | 5 | mm | 10 | mm |
| Sludge | None | None | None | | None | | 2 | mm | 5 | mm |
| Viscosity | 2500 cps | 2650 cps | 2750 | cps | 2700 | cps | 2500 | cps | 2250 | cps |

TABLE 10
Formula 4 - Evaluation Over 60-Day Storage

| | Time | 14 | 30 | 45 |
|---|---|---|---|---|
| | 0 | Days | Days | Days |
| pH | 4.6 | 4.6 | 4.55 | 4.55 |
| Color | White | Off-white | Off-white | Off-white |
| Taste | Good | Good | Good | Good |
| Separation | None | None | None | 2 mm |
| Sludge | None | None | None | None |
| Viscosity | 2600 cps | 2800 cps | 2750 cps | 2750 cps |

### Fifteen Percent Protein Yogurt Product, Stable at Room Temperature

The solids (MPC 85, 11 kg and WPI 1092, 105 kg) were dispersed into 666 kg milk and 11 kg pasteurized cream, and hydrated for 30 minutes at 52° C. The mixture was then heated to 70° C., homogenized at 2500 psi, then pasteurized at 75° C. for 30 seconds. The mixture was then cooled to 44° C. and inoculated with yogurt culture. After the product reached a pH of 4.6 (after incubation for 10-12 hours) it was broken with agitation.

Pectin (5 kg) was added to the fermented batch. The resulting mixture was heated and pasteurized at 75° C. for 15 seconds, then cooled to 25° C. and aseptically filled into sterile containers. Analysis revealed 15.8% protein, 2.9% fat, 28.4% solids, 450 mPas viscosity, TPC 200, yeast <10, mold <10, coliform <10, Staphylococcus <10, and bacterial spores 180.

### Seventeen Percent Protein Yogurt Product, Stable at Room Temperature

The solids (MPC 85, 10 kg and WPI 1092, 68 kg) were dispersed into 318 kg pasteurized whole milk and 7 kg pasteurized cream, then hydrated for 30 minutes at 52° C. The mixture was then heated to 70° C., homogenized, at 2500 psi, and then pasteurized at 75° C. for 30 seconds. The mixture was then cooled to 44° C. and inoculated with yogurt culture. After the product reached a pH of 4.6 (10-12 hours incubation), it was broken with agitation.

Sugar (30 kg), pectin (5 kg), gellan gum (0.8 kg), and 1 gallon of flavor was then added to the fermented batch. That product was then heated and pasteurized at 75° C. for 15 seconds, then cooled to 25° C. and aseptically filled into sterile containers. Analysis revealed 17.2% protein, 3.0% fat, 29.9% solids, 650 mPas viscosity, TPC 300, yeast <10, mold <10, coliform <10, Staphylococcus <10, and bacterial spores 120.

High-Protein Yogurt from Milk/Protein Powder

Yogurts were also produced by combining powder with water. Two separate products were made. The first combined 80% water with 10% whole milk powder and 10% whey protein isolate. The second combined 83% water with 8% non-fat dry milk, 2% milk protein isolate, and 7% whey protein isolate. These yogurt products could also be stored at room temperature and were generally indistinguishable from those made using liquid milk as the starting material.

What is claimed is:

1. A method for producing at least one shelf-stable yogurt product having a total protein content of at least about 12 percent, the method comprising the steps of
(a) preparing a fermentable yogurt milk by adding to milk at least one casein-containing component and/or at least one whey protein-containing component, to give a whey/casein ratio of from about 20:80 to about 90:10 in the fermentable yogurt milk;
(b) culturing the fermentable yogurt milk with at least one bacterial culture to produce at least one yogurt product; and
(c) aseptically packaging the yogurt product to provide a shelf-stable yogurt product, wherein at least one heat treatment is performed after step (a) and/or step (b) under pasteurization conditions that maintain at least about 75 percent of the whey protein in its undenatured state.

2. The method of claim 1 wherein the casein-containing component is selected from the group consisting of milk, cream, skim milk, MPC, MPI, non-fat dry milk (NFDM), UF milk, and combinations thereof.

3. The method of claim 1 wherein the whey protein-containing component is selected from the group consisting of milk, cream, skim milk, MPC, MPI, non-fat dry milk (NFDM), UF milk, WPC, WPI, and combinations thereof.

4. The method of claim 1 wherein the milk is liquid milk and/or milk powder.

5. The method of claim 1 wherein the total protein content comprises from about 12 percent to about 25 percent.

6. The method of claim 1 wherein at least about 95 percent of the whey protein is in the undenatured state.

7. The method of claim 1 wherein the shelf-stable high-protein yogurt product is a high-protein yogurt beverage.

8. The method of claim 7 wherein the shelf-stable high-protein yogurt beverage comprises at least about 12 percent protein.

9. A composition comprising a shelf-stable liquid yogurt comprising at least about 12 percent protein.

10. The composition of claim 9 wherein at least about 75 percent of the whey protein in the beverage is native protein.

11. The composition of claim 9 wherein the liquid yogurt has a viscosity of from about 50 to about 2000 centipoise.
